(19) United States
(12) Patent Application Publication
(10) Pub. No.: US 2010/0124852 A1
(43) Pub. Date: May 20, 2010

(54) ELECTRICAL CONNECTOR HAVING AN IMPROVED SWITCH

(75) Inventors: CHEN-XI WANG, Kunshan (CN); HONG-QIANG HAN, Kunshan (CN); LUN-SONG HU, Kunshan (CN); ZI-QIANG ZHU, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/618,800

(22) Filed: Nov. 16, 2009

(30) Foreign Application Priority Data
Nov. 14, 2008 (CN) 200810305571.0
Jul. 20, 2009 (CN) 200920306495.5

(51) Int. Cl. H01R 24/00

(52) U.S. Cl. 439/660

(57) ABSTRACT

An electrical connector for being mounted on a printed circuit board, includes an insulative housing defining a receiving space for receiving a mating plug; and a plurality of terminals assembled to the insulative housing and comprising at least one signal terminal, a first switch terminal moveable in an up-to-down/radial direction, and a pair of second switch terminals spaced from each other side by side. The first switch terminal is not provided with a soldering tail to be mounted on the print circuit board. The second switch terminals each having a soldering tail for being mounted on the printed circuit board. when the mating plug is inserted into the receiving space, the first switch terminal contacts the second switch terminals respectively to make the second switch terminals electrical connect with each other via the first switch terminal.

### BACKGROUND OF THE INVENTION

1. Field of the Invention

The present invention relates to an electrical connector, and particularly to an electrical connector having an improved switch.

2. Description of Prior Arts

With the ever-increasing miniaturization of computer and other electronic equipment, it becomes increasingly difficult to design electrical circuitry for connector thereof. One area of such difficulty is electrical switches or switch assemblies. An electrical switch assembly may be used as a normally open switch with switch contacts designed to be closed upon actuating the switch, or the switch assembly may be a normally closed switch with the contacts designed to be opened when the switch is actuated.

An electrical connector comprising an insulative housing and an insulative separator inserted into the housing. The separator has a U-shaped base portion for receiving a mating plug and a pair of movable pieces extending forwardly from the base portion. Between the movable pieces and the side walls of the housing, leaf contact pieces and metal plate contact pieces are inserted thereinto. The plate contact pieces are adjacent to the leaf contact pieces. Each leaf contact piece is longer than the adjoining plate contact piece and projects out towards the plate contact, and the free end portion of each leaf contact piece makes contact with the free end portion of the corresponding movable piece. When no plug is inserted, each leaf contact piece resiliently contacts the corresponding plate contact piece. When a plug is inserted into this audio jack connector, the pair of movable contact pieces are displaced by the plug outwardly in opposite directions, with the result that the leaf contact pieces are displaced, disengaging their contact portions from the plate contact pieces. The separator, the leaf contact pieces and the plate contact pieces are designed as an electrical switch assembly of this audio jack connector. Furthermore, because of the resilient contact between the leaf contact pieces and the corresponding plate contact pieces, the electrical switch assembly of this audio jack connector is used as a normally closed switch.

However, this kind of electrical connector cannot satisfy the requirement of ever-increasing miniaturization, because the separator thereof is complex and very large in a horizontal direction.

Hence, it is desirable to have an improved electrical connector to overcome the above-mentioned disadvantages of the prior art.

### SUMMARY OF THE INVENTION

According to one aspect of the present invention, an electrical connector for being mounted on a printed circuit board, comprises an insulative housing defining a receiving space for receiving a mating plug; and a plurality of terminals assembled to the insulative housing and comprising at least one signal terminal, a first switch terminal moveable in roughly a radial direction, a pair of second switch terminals spaced from each other along a lateral direction of the insulative housing, the second switch terminals each having a soldering tail for being mounted on the printed circuit board; wherein the first switch terminal and the second switch terminals are arranged side by side; wherein when the mating plug is inserted into the receiving space, the first switch terminal contacts the second switch terminals respectively to allow the second switch terminals to electrically connect with each other.

According to another aspect of the present invention, an electrical connector for being mounted on a printed circuit board, comprises an insulative housing a receiving space for receiving a mating plug; and a plurality of terminals retained in the insulative housing and comprising at least one signal terminal, a first switch terminal being moveable relative to the insulative housing in an radial direction perpendicular to a mating direction, and a pair of second switch terminals spaced from each other and each having a soldering tail for being mounted on the printed circuit board; wherein the first switch terminal is provided without any soldering tail to be mounted on the printed circuit board; wherein when the mating plug is inserted into the receiving space, the first switch terminal is deflectable along the radial direction to simultaneously contact with or disengage from the second switch terminals.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector in accordance with a first embodiment of the present invention;

FIG. 2 is another perspective view of the electrical connector shown in the FIG. 1;

FIG. 3 is a partially assembled view of FIG. 1 with a spacer and a metal shell of the electrical connector removed;

FIG. 4 is an exploded view of the electrical connector shown in FIG. 1;

FIG. 5 is another exploded view of the electrical connector shown in FIG. 1;

FIG. 6 is an exploded view of a switch of the electrical connector shown in FIG. 1;

FIG. 7 is a rear view of an insulative housing of the electrical connector shown in FIG. 1;

FIG. 8 is an exploded view of an electrical connector in accordance with a second embodiment of the present invention;

FIG. 9 is a partially assembled view of the electrical connector shown in the FIG. 8 and with a spacer and a metal shell of the electrical connector removed;

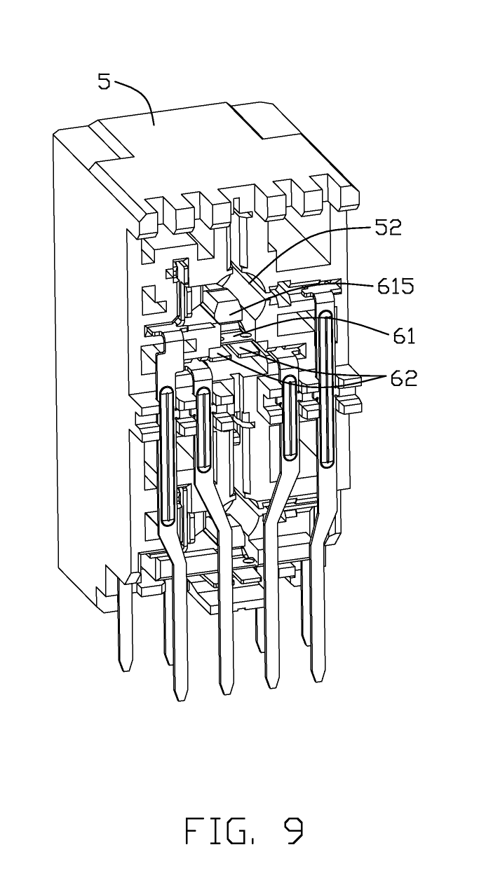

FIG. 10 is an assembled view of a first switch terminal of the electrical connector shown in the FIG. 8;

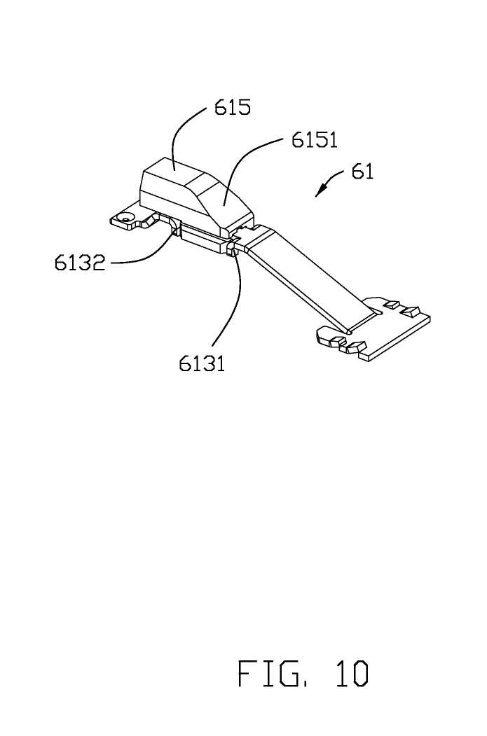

FIG. 11 is an exploded view of the first switch terminal shown in the FIG. 10; and

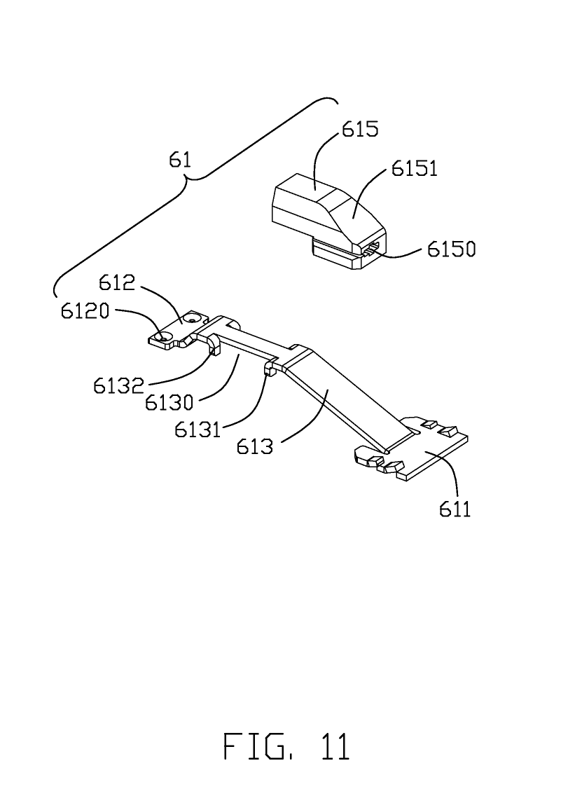

FIG. 12 is an exploded view of a switch of the electrical connector shown in the FIG. 8.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

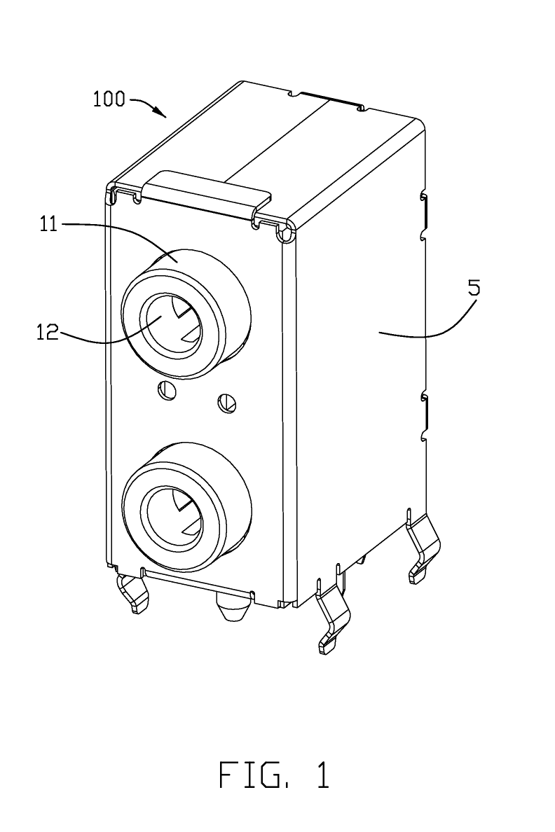

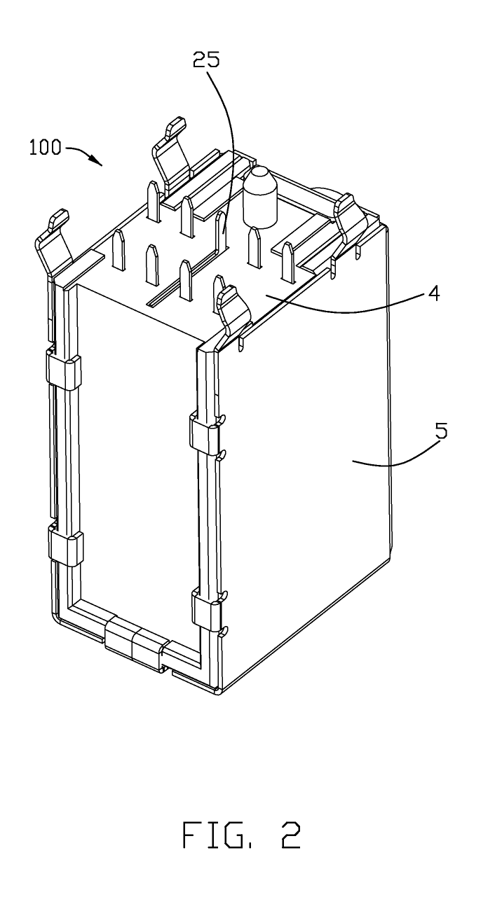

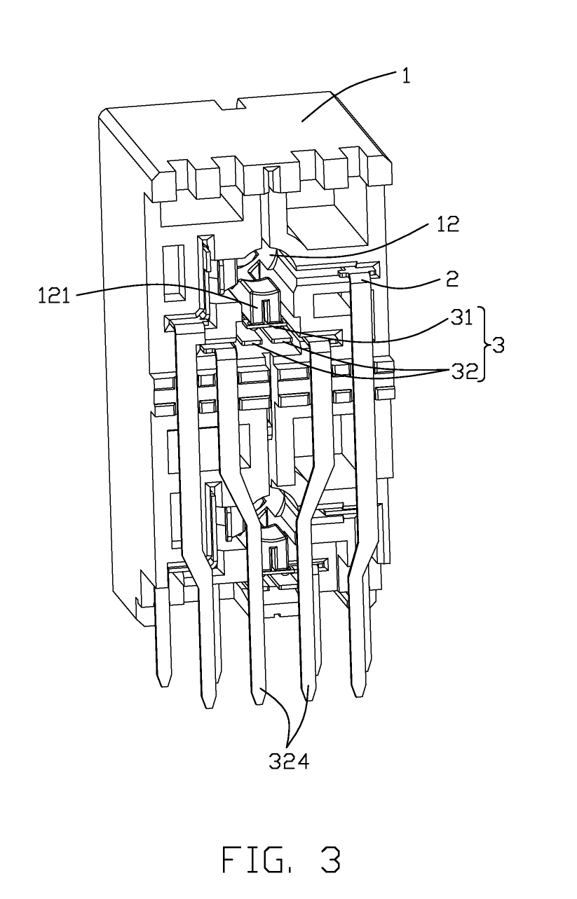

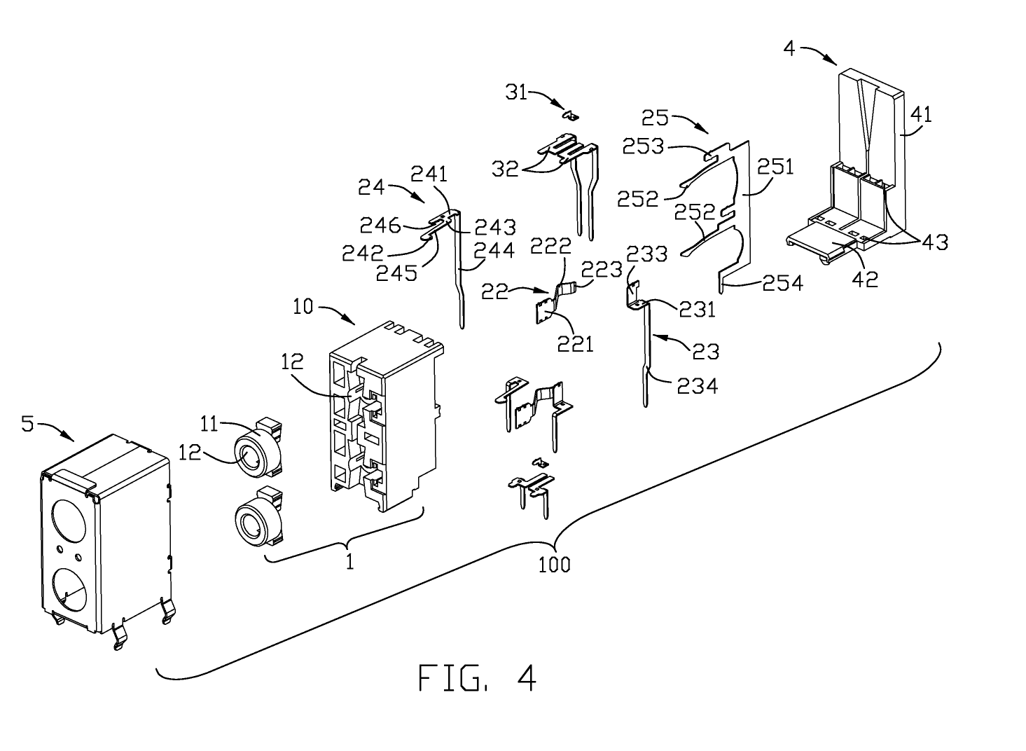

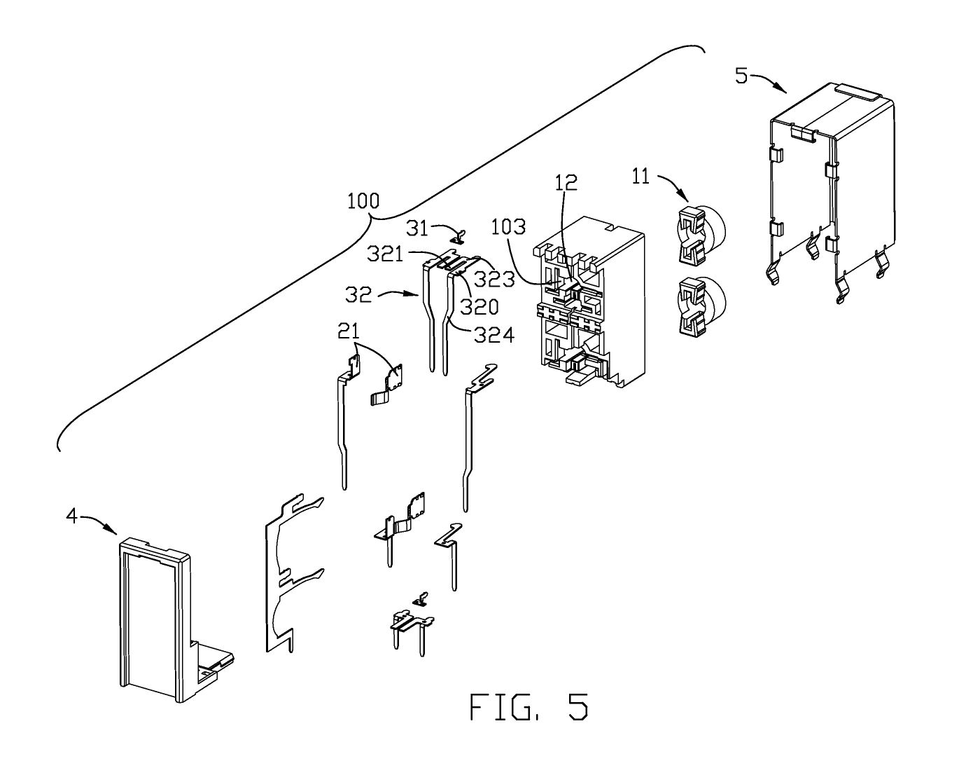

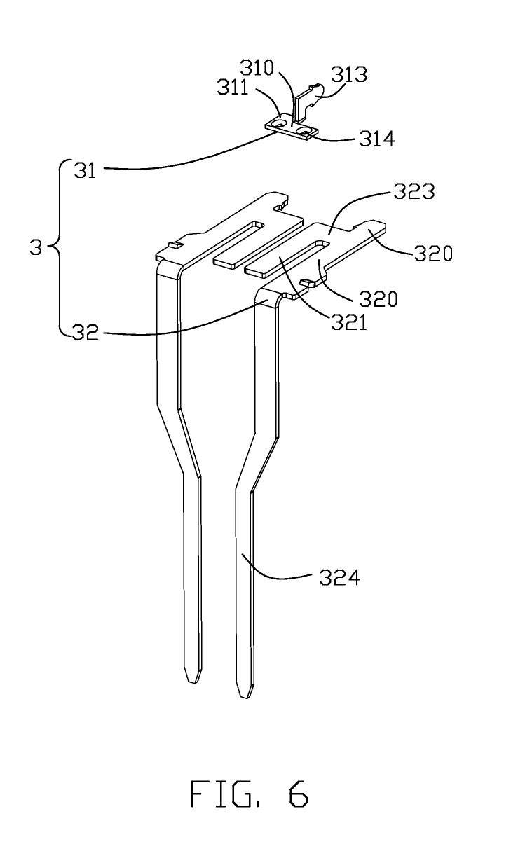

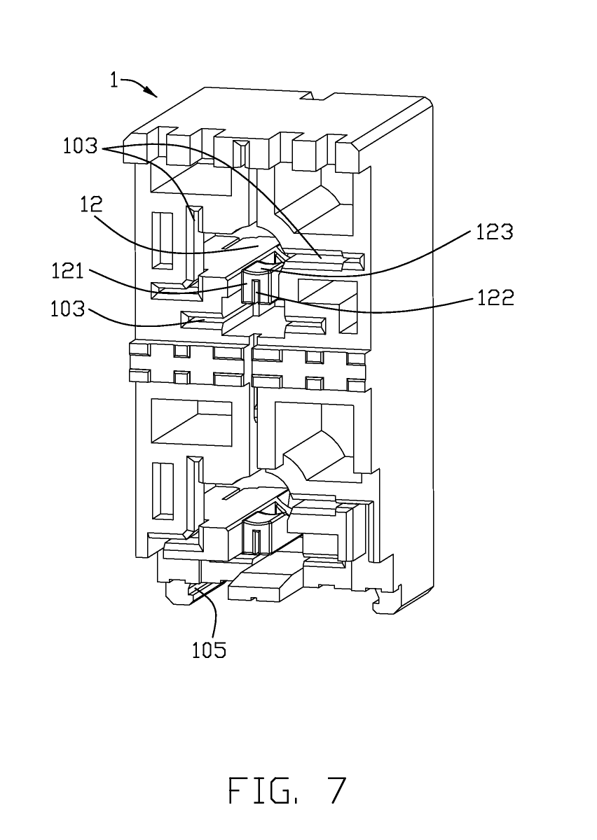

With reference to FIGS. 1-7, an electrical connector 100 in accordance with a first embodiment of the present invention, which is adapted for mounting on a printed circuit board (not shown) and receiving a receiving a mating plug, comprises: an insulative housing 1, at least one terminal unit assembled to the insulative housing 1, a spacer 4 and a metal shell 5 enclosing the insulative housing 1.

The insulative housing 1 includes a main body 10, a circular mating portion 11 retained on a front end of the main body 10, and a receiving space 12 extending through the mating portion 11 and the main body 10 along a front-to-back direction for receiving the mating plug. The main body 10 includes a plurality of passages 103 to retain the terminals, and an extruding arm 121 formed on an inner bottom surface of the receiving space 12 thereof. The passages 103 communicate with the receiving passages 103 and extend downwardly through the main body 10. A bottom portion of a rear end of the extruding arm 121 defines a retaining slot 122 extending backwardly through therein. A top portion of the extruding arm 121 defines an arc depression 123 disposed in the receiving space 12 for engaging with a circular section of the mating plug. A bottom portion of the main body 10 defines a locating slot 105 for retaining the spacer 4.

Each of terminal unit includes a first signal terminal 21 formed by a mating terminal 22 and a transition terminal 23 contacting the mating terminals 22, a second signal terminal 24, a grounding terminal 25, and a switch 3. The mating terminal 22 includes a locating portion 221 retained in the passage 103 of the insulative housing 1, an arc elastic mating portion 222 slantways extending rearwardly from the locating portion 221 into the receiving space 12 of the insulative housing 1 for engaging with the mating plug, and a first engaging portion 223 disposed on a distal end of the mating portion 222. The transition terminal 23 includes a level locating portion 231 retained in the passage 103 of the insulative housing 1, a second engaging portion 233 bending vertically and extending upwardly from an inner side of the locating portion 231, and a soldering tail 234 extending downwardly from a rear end of the locating portion 231 for being mounted on the printed circuit board. The first engaging portion 223 of the mating terminal 22 contacts the second engaging portion 233 of the transition terminal 23 while the mating portion 222 abuted by the mating plug. It is noted that the mating terminal 22 is rearwardly assembled into the housing 1 from a front face (not labeled) thereof with the locating portion 221 lying in a vertical plane for retaining the mating terminal 22 to the housing 1, and with the arc elastic mating portion 222 rearward extending from the locating portion 221 and having a mating portion for engagement with the inserted plug and an engaging portion thereof, while the transition terminal 23 is forwardly assembled into the housing 1 from a rear face (not labeled) thereof with the lever locating portion 231 lying in a horizontal plane for retaining the transition terminal 23 to the housing 1, and with another engaging portion 233 lying in a vertical plane for engagement with the engaging portion of the mating terminal 22. Understandably, the assembling of the mating terminal 22 and of the transition terminal 23 to the housing 1 in opposite directions from opposite front and rear faces of the housing 1 with the locating portion 221 of the mating portion 22 being located in a front portion of the housing 1 while the lever locating portion 231 of the transition terminal 23 being located in a rear portion of the housing 1, provides an efficient/convenient arrangement of the terminals 22 and 23 in the housing 23 compared with both those two terminals are assembled forwardly into the housing from the rear face of the housing.

The second signal terminal 24 includes a level locating portion 241 retained in the passages 103 of the insulative housing 1, a connect portion 243 extending inwardly from the locating portion 241, a flexible portion 245 extending forwardly from the connect portion 243, a soldering tail 244 extending downwardly from a rear end of the locating portion 241 for connecting to the printed circuit board, and a mating portion 242 disposed on a distal end of the flexible portion 245 for engaging with the mating plug. A gap 246 is formed between the locating portion 241 and the flexible portion 245. The gap 246 could allow the mating portion 242 to be deflectable. The locating portion 241, the mating portion 242 and the flexible portion 245 are arranged in one level surface.

The grounding terminal 25 includes a vertical body strip 251, two arms 252 horizontally extending forward from the body strip 31 into the receiving space 12 of the insulative housing 1. The arms 252 are spaced apart and parallel to each other. A pair of protrusions 253 extends forwardly from the body strip 251 of the grounding contact 25, and adjacent to the top two arms 252, respectively. A soldering tail 254 extends downwardly from the bottom arm 252 for being soldered to the printed circuit board.

The switch 3 includes a first switch terminal 31 and a pair of second switch terminals 32 spaced from each other along a lateral direction of the insulative housing 1. The first switch terminal 31 is disposed whole above the second switch terminals 32 and includes a first level base portion 310 abutting against the bottom portion of the extruding arm 121 of the insulative housing 1, a pair of first contact portion 311 disposed on opposite ends of the first base portion 310, a first retaining portion 313 retained in the retaining slot 122 of the extruding arm 121. The first contact portions 311 each defines an emboss 314 protruding downwardly therefrom.

The second switch terminals 32 are symmetric with each other in a left-to-right direction. The second switch terminals 32 each has a second retaining portion 320 retained in the passages 103 of the insulative housing 1, a connect portion 323 extending inwardly from a front end of the second retaining portion 320, a fixing plate 322 protruding forwardly from the front end of the second retaining portion 320, a second contact portion 321 extending rearwardly from the connect portion 323 and spaced from the second retaining portion 320, and a soldering tail 324 bending and extending downwardly from a rear end of the second retaining portion 320 for connecting to the printed circuit board. All the second retaining portions 320, the second contact portions 321, the fixing plates 322, and the connect portions 323 of the pair of second switch terminals 32 are arranged in another level surface.

The spacer 4 is generally step-shaped and includes an vertical panel 41 and a base 42 extending forwardly from a bottom end of the panel 41 and defining a plurality of through holes 43 extending therethrough. The base 42 is retained in the locating slot 105 of the insulative housing 1. All the soldering tails 234, 244, 254, 324 of the terminals extend through the through holes 43 respectively.

When the mating plug is inserted into the receiving space 12 of the electrical connector 100, the extruding arm 121 is abuted by the mating plug to move downwardly, and thus drive the first switch terminal 31 to contact the second switch terminals 32 respectively. The embosses 314 of the first switch terminal 31 contact the contact portion 321 of the second switch terminals 32 to make the second switch terminals 32 electrical connect with each other via the first switch terminal 31.

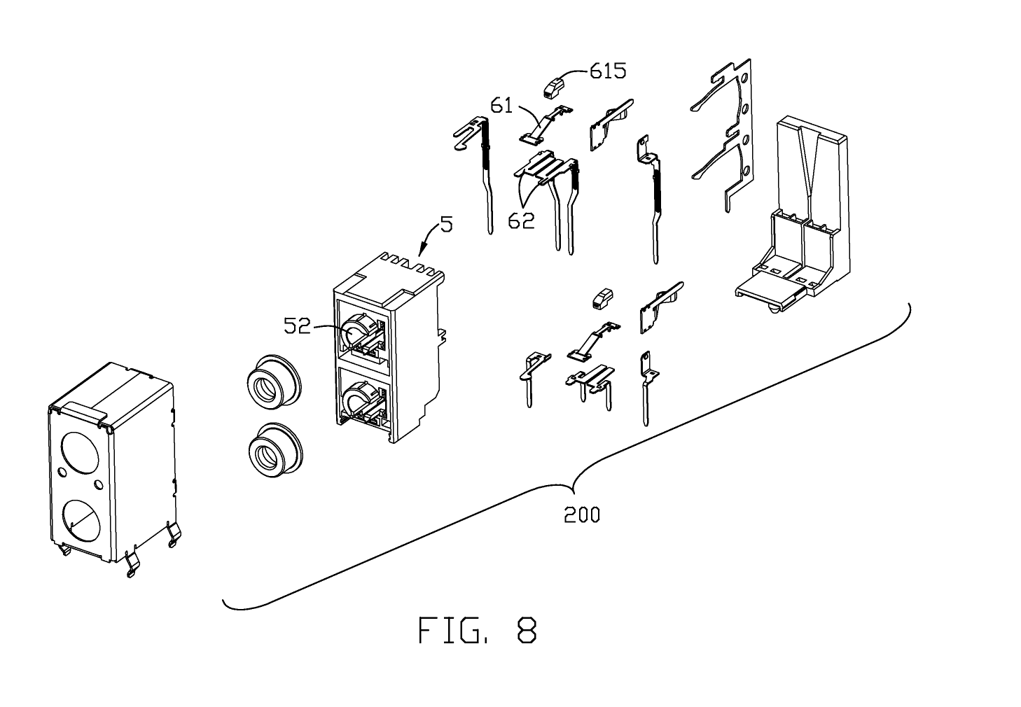

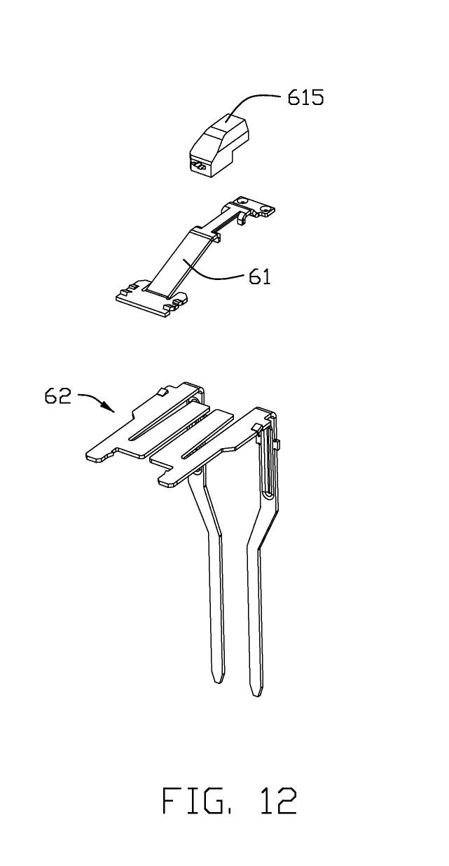

Referring to FIGS. 8 and 12, the first switch terminal 61 of an electrical connector 200 in accordance with a second embodiment of the present invention is different from the first switch terminal 31 in accordance with the first embodiment. The second switch terminals 62 in accordance with the second embodiment are same as the second switch terminals 32 in accordance with the first embodiment. The first switch terminal 61 includes a base portion 611 retained in an insulative housing 5 of the electrical connector 200 having a receiving space 52 for receiving the mating plug, a first contact portion 612, a spring arm 613 slantways extending reawardly from the base portion 611 to the first contact portion 612, and an insulative separator 615 disposed in the receiving space 52. The spring arm 613 defines a pair of opening 6130 in opposite sides thereof, a first flange 6131 splited downwardly from a front edge of the opening 6130, and a second flange 6132 splited downwardly from a rear edge of the opening 6130. The first contact portion 612 bends from the spring arm 613 firstly, and extends rearwardly then. The first contact portion 612 is disposed above the second switch terminals 62 and defined a pair of embosses 6120 for contacting the second switch terminals 62 while the mating plug is inserted into the receiving space 52.

The separator 615 mounted only to the spring arm 613 without direct engagement with the insulative housing 5, and essentially located in an insertion path of the mating plug. The separator 615 defines a groove 6150 engaging with the openings 6130, and a front inclined surface 6151. The separator 615 is sandwiched between the first flange 6131 and the second flange 6132, and thus prevented from moving relative to the first switch terminal 61 in the front-to-back direction.

When the mating plug is inserted into the receiving space 52 of the electrical connector 200, the mating plug move along the inclined surface 6151 and push the separator 615 first downwardly, so the spring arm 613 of the first switch terminal 61 rotates away from the receiving space 52 and towards the second switch terminals 62. As the insertion the mating plug continues, the embosses 6120 of the first contact portion 612 of the first switch terminal 61 contacts the second switch terminals 62, and thus the second terminals 62 electrical connect with each other via the first switch terminal 61.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An electrical connector for being mounted on a printed circuit board, comprising:
an insulative housing defining a receiving space for receiving a mating plug; and
a plurality of terminals assembled to the insulative housing and comprising at least one signal terminal, a first switch terminal moveable in roughly a radial direction, a pair of second switch terminals spaced from each other along a lateral direction of the insulative housing, the second switch terminals each having a soldering tail for being mounted on the printed circuit board;
wherein the first switch terminal and the second switch terminals are arranged side by side;
wherein when the mating plug is inserted into the receiving space, the first switch terminal contacts the second switch terminals respectively to allow the second switch terminals to electrically connect with each other.

2. The electrical connector as described in claim 1, wherein the insulative housing integrally forms an extruding arm extending into the receiving space and moveable in the radial direction, the first switch terminal is located on the extruding arm, and thus wholly above the second switch terminals; when the mating plug is inserted into the receiving space, the extruding arm is engaged by the mating plug to move, and thus drive the first switch terminal to contact the second switch terminals respectively.

3. The electrical connector as described in claim 2, wherein the first switch terminal includes a first level base portion abuting against a bottom portion of the extruding arm, and a pair of first contact portions formed on opposite ends of the base portion to connect or disconnect to the second switch terminals.

4. The electrical connector as described in claim 3, wherein the first switch terminal is inflexible and includes a first retaining portion extending upwardly and vertically from the first base portion, the bottom portion of extruding arm defining a retaining slot to retain the first retaining portion, and the retaining slot extends rearwardly and through the extruding arm.

5. The electrical connector as described in claim 3, wherein the pair of second switch terminals each has a second contact portion to connect or disconnect the first switch terminal, the second contact portions of the second switch terminals are arranged in one level surface and apart from each other side by side, and the second contact portions are parallel to the first contact portion of the first switch terminal.

6. The electrical connector as described in claim 1, wherein the pair of second switch terminals are symmetric with each other in a left-to-right direction, the second switch terminals each has a second retaining portion retained in the insulative housing, a connect portion extending inwardly from a front end of the second retaining portion, and a second contact portion extending rearwardly from the connect portion and spaced from the second retaining portion, the soldering tail bends and extends downwardly from a rear end of the second retaining portion, the second retaining portions, and the second contact portions and the connect portions of the second switch terminals are arranged in one level surface.

7. The electrical connector as described in claim 1, said first switch terminal is retained to the housing with an insulative separator disposed on the first switch terminal and extending into the receiving space; when the mating plug is inserted into the receiving space, the separator is abutted by the mating plug to move in the radial direction, and thus drive the first switch terminal to contact with the second switch terminals respectively.

8. The electrical connector as described in claim 7, wherein the first switch terminal includes a base portion retained in the insulative housing, a first contact portion to connect or disconnect with the second switch terminals respectively, and a spring arm slantways extending reawardly from the base portion to the first contact portion, the spring arm defines a pair of openings in opposite sides thereof, a first flange splited downwardly from a front edge of the openings, and a second flange splited downwardly from a rear edge of the openings, the separator defines a groove engaging with the openings, the separator is sandwiched between the first flange and the second flange.

9. An electrical connector for being mounted on a printed circuit board, comprising:
an insulative housing a receiving space for receiving a mating plug; and
a plurality of terminals retained in the insulative housing and comprising at least one signal terminal, a first switch terminal being moveable relative to the insulative housing in an radial direction perpendicular to a mating direction, and a pair of second switch terminals spaced from each other and each having a soldering tail for being mounted on the printed circuit board;
wherein the first switch terminal is provided without any soldering tail to be mounted on the printed circuit board;
wherein when the mating plug is inserted into the receiving space, the first switch terminal is deflectable along the radial direction to simultaneously contact with or disengage from the second switch terminals.

10. The electrical connector as described in claim 9, wherein the first switch terminal defines a first base portion retained in a front end of the insulative housing, the second switch terminals each defines a second base portion retained in a rear end of the insulative housing.

11. The electrical connector as described in claim 9, wherein the insulative forms an extruding arm extending into the receiving space, the first switch terminal is retained on the extruding arm, when the mating plug is inserted into the receiving space, the extruding arm is abutted against by the mating plug, and thus drives the first switch terminal to connect the second switch terminals respectively.

12. The electrical connector as described in claim 11, wherein the extruding arm defining a retaining slot extending rearwardly through the thereon, the first switch terminal defines a first retaining portion retained in the retaining slot, and a pair of contact portions for contacting or disengage from the second switch terminals respectively.

13. The electrical connector as described in claim 9, further comprising an insulative separator mounted only to the first switch terminal without direct engagement with the insulative housing, and essential located in an insertion path of the mating plug, when the mating plug is inserted into the receiving space, none of the first switch terminal and the second switch terminals but the separator is engaging with the mating plug under a condition that the first switch terminal is deflected.

14. The electrical connector as described in claim 13, wherein the first switch terminal is connect with each of the second switch terminals when the mating plug is inserted into the receiving space, and the first switch terminal is connect with none of the second switch terminals when the mating plug is removed from the receiving space.

15. The electrical connector as described in claim 13, wherein the first switch terminal includes a base portion retained in the insulative housing, a first contact portion to connect or disconnect with the second switch terminals respectively, and a spring arm slantways extending reawardly from the base portion to the first contact portion, the spring arm defines a pair of openings in opposite sides thereof, a first flange splited downwardly from a front edge of the openings, and a second flange splited downwardly from a rear edge of the openings, the separator defines a groove engaging with the openings, the separator is sandwiched between the first flange and the second flange.

16. The electrical connector as described in claim 9, wherein the pair of second switch terminals are symmetric with each other in a left-to-right direction, the second switch terminals each has a second retaining portion retained in the insulative housing, a connect portion extending inwardly from a front end of the second retaining portion, and a second contact portion extending rearwardly from the connect portion and spaced from the second retaining portion, the soldering tail bends and extends downwardly from a rear end of the second retaining portion, the second retaining portions, the second contact portions and the connect portions of the second switch terminals are arranged in one level surface.

17. An electrical connector assembly for mounting to a printed circuit board, comprising:
an insulative housing defining opposite front and rear faces with a receiving space rearwardly extending from the front face therein for receiving a mating plug;
a first terminal defining a first locating portion lying in a first plane and fixedly received in a first slot for retaining said first terminal to the housing, an elastic mating portion extending rearwardly from the first locating portion for mating with a plug received in the receiving space; and
a second terminal defining a second locating portion lying in a second plane and fixedly received in a second slot for retaining said second terminal to the housing;
said elastic mating portion being equipped with a first engaging portion to abut against an engaging portion formed on the second terminal when said elastic mating portion is outwardly deflected by the plug; wherein
the first slot extends through the front face and the second slot extends through the rear face so as to have the first terminal rearwardly assembled into the housing from the front face while the second terminal forwardly assembled into the housing from the rear face under condition that the second terminal is equipped with a tail portion for mechanically and electrically connecting to the printed circuit board while the first terminal not.

18. The electrical connector assembly as claimed in claim 17, wherein the second plane is perpendicular to the first plane.

19. The electrical connector assembly as claimed in claim 18, wherein the second engaging portion lies in a third plane parallel to the first plane and perpendicular to the second plane.

20. The electrical connector assembly as claimed in claim 17, wherein said first locating portion is positioned in front of the second locating portion.
